(19) United States
(12) Patent Application Publication
(10) Pub. No.: US 2011/0231247 A1
(43) Pub. Date: Sep. 22, 2011

(54) Pay-Per-Call ad system

(76) Inventors: Thirunarayanan Srinivasan, Highlands Ranch, CO (US); Ramesh Ramamurthy, Highlands Ranch, CO (US); Krishnan Kannan, Englewood, CO (US); Gopakumar Padmanabhan, Highlands Ranch, CO (US)

(21) Appl. No.: 12/728,311

(22) Filed: Mar. 22, 2010

(51) Int. Cl. G06Q 30/00; G06Q 10/00; G06Q 20/00; G06F 17/30; H04M 3/42

(52) U.S. Cl. 705/14.43; 705/14.46; 707/769; 379/212.01; 707/802; 707/E17.014; 707/E17.005; 707/E17.044

(57) ABSTRACT

A method and system are provided for connecting consumer searches and phone calls. In accordance with one or more embodiments, the method includes the steps of (a) receiving from a search system and storing the search results relating to an online or mobile search performed by a consumer, the search results identifying one or more telephone numbers of merchants that signed up with the search system as Advertisers, and the search association identifiers such as IP Address, Cookie, and/or Carrier User ID associated with the consumer; (b) associating the Automatic Number Identification (ANI) to the online or mobile search by matching the search association identifiers based on two phone calls originated from the same ANI within a predetermined period of time of the one or more searches; (c) charging the selected Advertiser a fee for connecting the consumer to the selected Advertiser; and (d) providing detailed Return-On-Investment reports.

### RELATED APPLICATIONS

The present application is related to U.S. patent Ser. No. ______ The pending United States Patent Application 20080086384 from LeadHancer, Inc., issued Jan. 25, 2007, by Thirunarayanan Srinivasan, Ramesh Ramamurthy, Kannan Krishnan, Murali Anakavur, and Gopakumar Padmanabhan, included by reference herein.

### FIELD OF THE INVENTION

The present invention relates to pay-per-call solution and, more particularly, to associating the online and mobile searches and phone calls automatically and in an anonymous manner.

### BACKGROUND OF THE INVENTION

In a Pay-Per-Call (PPCall) system, a lead is raised only when a phone call is delivered to the Advertiser. The phone number displayed in the ad can be a tracking phone number or an existing phone number of the Advertiser since the business was founded and advertised in print phone books, newspaper ads, and coupons. However, the system cannot provide proof that the user placed the call only after a corresponding search and cannot ensure that each impression of the ad results in utmost one lead. This is because users perform searches in an anonymous manner in search engines such as Google, Bing, and Yahoo! and each impression of the ad can result in one or more leads payable by the Advertiser.

Current PPCall vendors' technology is based on tracking phone number. This technology lacks the sophistication in providing details of Keywords and Campaigns that were responsible for the calls delivered unless the Advertiser uses more than one tracking phone number for the same ad. That is, to track and detailed Return-On-Investment (ROI) reports, the technology uses multiple tracking phone numbers either one for each Keyword/Campaign or for the browser session. Having multiple phone numbers means the cost of the advertisement becomes expensive and could lead to phone number provisioning, quality control, and ad management issues.

The pending United States Patent Application 20080086384 from LeadHancer, Inc. allows the search to be associated to the subsequent phone call. However, the limitation of the system lies in the fact that the method of matching the online search to the phone call depends on using the Advanced Intelligent Network (AIN) architecture. It also does not deal with associating mobile searches to calls.

To overcome the problem of providing proof of the search, current PPCall vendors use a tracking phone number in the ad. Presumably, users that did the search only know the tracking phone number. However, the user that performed the search may pass on the tracking phone number to others and each phone call made by the recipient results in a lead. While the calls made by the recipients result in new leads and, possibly, new business, to the Advertiser, the proof that the callers performed the search is lacking.

It should be noted that both the current vendors' technology and the pending LeadHancer's Patent Application 20080086384 lack the ability to provide detailed ROI reports that contain Keywords and Campaigns that were responsible for the leads delivered to the Advertiser.

would be advantageous to provide proof that each ad impression can result in no more than one chargeable lead.

It would also be advantageous to provide proof of consumer's search that led to the phone call.

It would further be advantageous to provide a detailed ROI report.

### SUMMARY OF THE INVENTION

A method and system are provided for connecting consumer searches and phone calls. In accordance with one or more embodiments, the method includes the steps of (a) receiving from a search system and storing the search results relating to an online or mobile search performed by a consumer, the search results identifying one or more telephone numbers of merchants that signed up with the search system as Advertisers, and the search association identifiers such as IP Address, Cookie, and/or Carrier User ID associated with the consumer; (b) associating the Automatic Number Identification (ANI) to the online or mobile search by matching the search association identifiers based on two phone calls originated from the same ANI within a predetermined period of time of the one or more searches performed by the consumer; (c) charging the selected Advertiser a fee for connecting the consumer to the selected Advertiser; and (d) providing detailed Return-On-Investment reports to the Advertiser and search system containing the search time, call time, call duration, latency, IP Address, Cookie, keywords, campaign, and lead fee.

Various embodiments of the invention are provided in the following detailed description. As will be realized, the invention is capable of other and different embodiments, and its several details may be capable of modifications in various respects, all without departing from the invention. Accordingly, the drawings and description are to be regarded as illustrative in nature and not in a restrictive or limiting sense, with the scope of the application being indicated in the claims.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a pay-per-call ad system receiving and storing search results containing advertisers;

FIG. 2 is a perspective view of a pay-per-call ad system associating call to search;

FIGS. 3A, 3B, and 3C are an exploded view of a pay-per-call ad system storing the data in lh merchant db tables;

FIG. 4 is an exploded view of a pay-per-call ad system of storing the data in lh cdr server tables;

FIGS. 5A and 5B are a perspective view of a pay-per-call ad system executing the correlation logic; and

FIG. 6 is a perspective view of a pay-per-call ad system to allow viewing of roi reports by the advertiser.

For purposes of clarity and brevity, like elements and components will bear the same designations and numbering throughout the Figures.

### DESCRIPTION OF THE PREFERRED EMBODIMENT

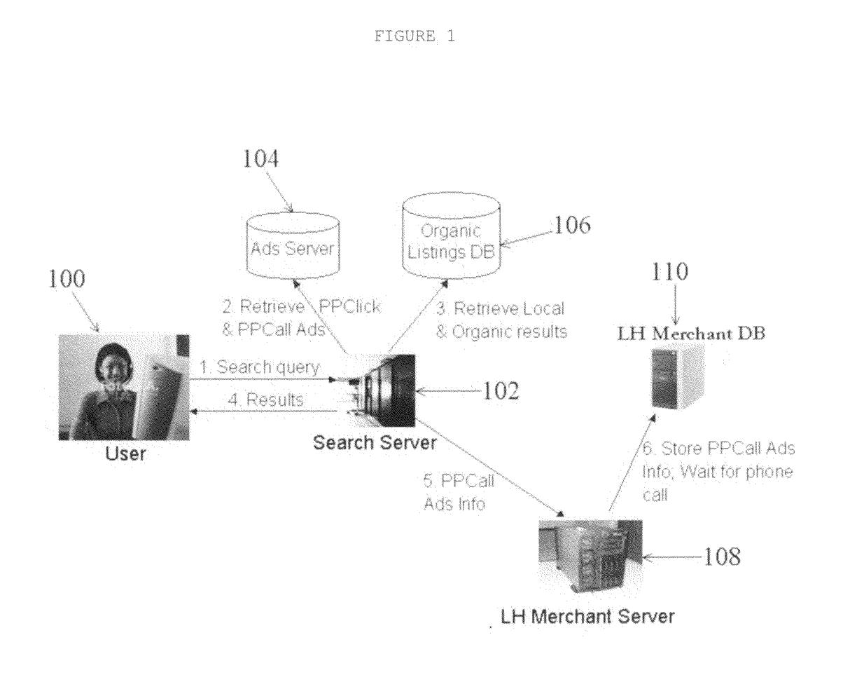

FIG. 1 is a perspective view of receiving and storing search results, in accordance with the invention. A user 100 performs either an online or mobile search in a search system comprising a Search Server 102. The Search Server 102 consists of one or more computers interconnected within a data center(s) as in the case of search engines like Google, Microsoft's Bing, and Yahoo!. In the case of mobile searches, the WAP (Wireless Access Protocol) Server hosted by the search system receives the search query and forwards the same to the Search Server 102.

Search Server 102 is attached to an Ads Server 104 that contains both Pay-Per-Call (PPCall) and Pay-Per-Click (PPClick) ads. Typically, Ads Server 104 consists of one or computers interconnected within a data center(s). Search Server 102 is also attached to an Organic Listings DB that provides search results containing the local and natural listings displayed to the user 100. Based on the search query entered, Search Server 102 displays the search results consisting of relevant ads and natural listings to the user 100. The ads in turn consist of PPCall and/or PPClick Advertisers. Search Server 102 determines the relevant PPCall ads from the Ads Server 104. Such ads selected for display to the user 100 will be associated with a Directory Number (DN), one or more Keywords, and one or more Campaign Names that contain one or more Keywords as configured by the Advertiser 204 with the search system. The DN may be a tracking phone number, existing phone number, or a routing number, and is commonly referred to as the DN for reference purposes throughout this invention. If the ad were to display a toll-free number, then the telephony network converts it into a routing number before delivering the call to the Advertiser 204. The Advertiser 204 also specifies the bid amount to be charged for a valid lead delivered in the form of a phone call in the Ads Server 104.

Along with the search query, Search Server 102 also receives the search association identifiers such as IP Address and Cookie for an online search vs. Carrier UserID and Cookie for a mobile search from the user 100. Search Server 102 sends a search results message with parameters such as IP Address/Carrier UserID, Cookie, search_time, search_type (online or mobile), and one or more Directory Numbers (DNs), Keywords for respective DNs (optional), Campaign Names for respective DNs (optional) of the PPCall ads to LH Merchant Server 108, where “LH” stands for LeadHancer. While the user 100 may block the Cookie through the browser options, Search Server 102 always generates it and passes it to LH Merchant Server 108 even though the Search Server 102 cannot write it to the user's computer or mobile device. For mobile searches, however, the Search Server 102 always receives the Carrier UserID associated with the mobile device, which is a unique value that cannot be blocked by the user 100 because the value is sent by the mobile carrier's WAP Gateway to the WAP Server hosted by the search system. LH Merchant Server 108 stores the parameters received in a table called Search_Records 304 in the LH Merchant DB, provided the DN is present in the PPCall_Advertisers 300 table. Each record in the Search_Records 304 table has a unique index of search_record_id. The Search Server 102 passes the Carrier UserID value in the IP Address field to the LH Merchant Server 108. Therefore, all references to IP Address in the context of mobile searches mean the Carrier UserID. The records in the Search_Records 304 table will be set to expire at search_time+a predetermined value. A scheduled process running in the LH Merchant Server 108 will purge the expired records from the Search_Records 304 table based on current time.

In one embodiment of the invention, it is possible that the user 100 may perform a search after deleting the Cookies through the browser options while the IP Address remains the same as the previous search(s). Alternatively, the user 100 may perform a search with a newly assigned IP Address from their ISP (Internet Service Provider) while maintaining the same Cookie as the previous search(s). In both cases, upon receipt of the message containing the search results, LH Merchant Server 108 determines one or more records in the ANIs_Learned 310 table that match the said IP Address or said Cookie, as the case maybe, and then creates new records in the ANIs_Learned 310 table with the said IP Address and Cookie present in the search results message sent by the Search Server 102, same ANI as the present said record of the ANIs_Learned 310 table, and time_of_last_call equal to said search_time present in the search results message sent by the Search Server 102.

In another embodiment of the invention, if there is no change in the IP Address and Cookie, then LH Merchant Server 108 extends the expiration_time of the matching records of the First_Call_History 306 table with a value of said search_time present in the search results message sent by the Search Server 102+a predetermined value.

In yet another embodiment of the invention, if there is a change in either the IP Address or Cookie, then LH Merchant Server 108 determines one or more records in the First_Call_History 306 table that match the said IP Address or said Cookie, as the case maybe, and then creates new records in the First_Call_History 306 table with the said IP Address, Cookie, keywords, and campaign_name present in the search results message sent by the Search Server 102, same DN, ANI, search_record_id, search_time, call_time, call_id, and duration as the present said record of the First_Call_History 306 table, and expiration_time equal to said search_time present in the search results message sent by the Search Server 102+a predetermined value.

LH Merchant Server 108 may be hosted either inside or outside the search system's firewall. For privacy reasons, a search system may pass•encrypted values of the IP Address, Cookie/Carrier UserID, Keywords, and Campaign Names to LH Merchant Server 108. LH Merchant Server 108 stores the received parameters in the LH Merchant DB for a predetermined amount of time until a phone call is received from the user 100. LH Merchant Server 108 consists of one or more computers interconnected with a datacenter(s). LH Merchant DB consists of one or more computers interconnected with a datacenter(s) running popular databases like Oracle, My*SQL, or SQL Server and maybe contained in the LH Merchant Server 108.

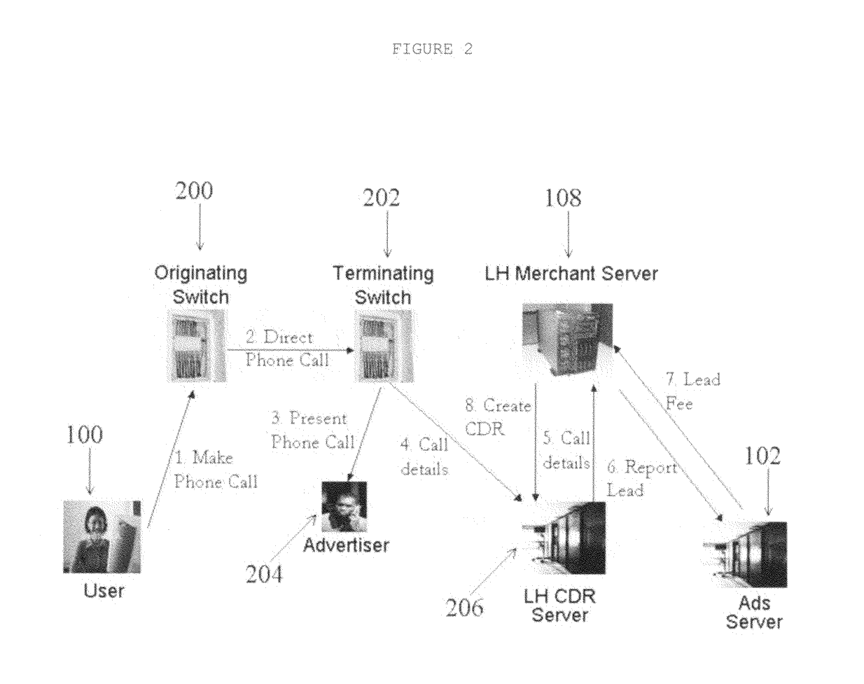

FIG. 2 is a perspective view of the associating call to search, in accordance with the invention. After performing a search, user 100 places a phone call to a PPCall Advertiser 204 by dialing the phone number displayed in the ad. The Originating Switch passes the call to the Terminating Switch 202 through the telephone network. The Originating Switch and Terminating Switch 202 may be a traditional phone switch like 5ESS or a VoIP (Voice Over Internet Protocol) platform from any number of vendors, including Lucent, Inc. and Avaya, Inc. and hosted by the search system, a telephone company, or a 3rd party vendor. The telephone network may be based on wireline and wireless technologies.

The PPCall ads displayed to the user 100 may use either a tracking phone number or the existing phone number of the Advertiser 204 that appears in print phone books, newspaper ads, and coupons. In the case of mobile searches, it is possible to display the existing phone number in the ad while having a hidden tracking phone number behind it through a Tel URL so that when the user 100 makes a Click-to-call, the phone software calls the tracking phone number, which in turn call forwards to the Advertiser's existing phone number. Alternatively, it is also possible that the ad displays the existing phone number that is call forwarded to a tracking phone number so that the Terminating Switch 202 routes the call to a different phone number of the Advertiser 204.

Terminating Switch 202 receives the Directory Number (DN) and Automatic Number Identification (ANI) parameters as part of the call setup message received from the Originating Switch. Terminating Switch 202 presents the call to the Advertiser 204. Depending on the Advertiser's line status, the Terminating Switch 202 may encounter one of busy, no answer, answer, or disconnect events. These events are part of any normal call processing logic encountered by the Terminating Switch 202. Of these, Terminating Switch 202 passes only such events as busy, no answer, and disconnect to LH CDR Server 206. In addition, Terminating Switch 202 also passes the timestamp of event and duration (applies only in case of disconnect event and will be set to 0 for others) parameters to LH CDR Server 206. LH CDR Server 206 consists of one or more computers interconnected in a data center(s) and hosted either inside or outside the firewall of the search system, a telephone company, or a 3rd party vendor.

LH CDR Server 206 functionality includes: 1) Determining if the DN is a valid PPCall Advertiser 204; 2) Storing Call Detail Records (CDRs) of valid leads raised by LH Merchant Server 108; and 3) Upon request from Ads Server 104, provide the ANI in clear-text for viewing by Advertiser 204 when the latter views the ROI reports.

At the time of Advertiser 204 sign-up for PPCall service with the search system, the Ads Server 104 passes the DN, Category, Address (optional), City (optional), State (optional), Zip Code (optional) to LH Merchant Server 108. LH Merchant Server 108 stores the data in a PPCall_Advertisers 300 table in the LH Merchant DB. In addition, LH Merchant Server 108 passes the data to LH CDR Server 206, which in turn stores the data in a table called PPCall_DNs 400. The Category parameter is used to allow the search system specify different intervals for determining repeat leads so that the Advertiser 204 is not billed for delivering repeat calls originated by the same ANI with or without an accompanying search performed by the user 100.

After receipt of the message from the Terminating Switch 202, LH CDR Server 206 determines if the DN is a valid PPCall Advertiser 204 per the PPCall_DNs 400 table. If so, LH CDR Server 206 generates a call_id and then stores the call_id, ANI, DN, call_start_time, and duration parameters in a PPCall_Qualifiers 402 table. Note that the duration parameter applies only to the disconnect event type. LH CDR Server 206 then passes the call_id, DN, ANI, event_type, call_time, and/or duration parameters to LH Merchant Server 108. For privacy reasons, LH CDR Server 206 may encrypt the ANI before sending it to LH Merchant Server 108.

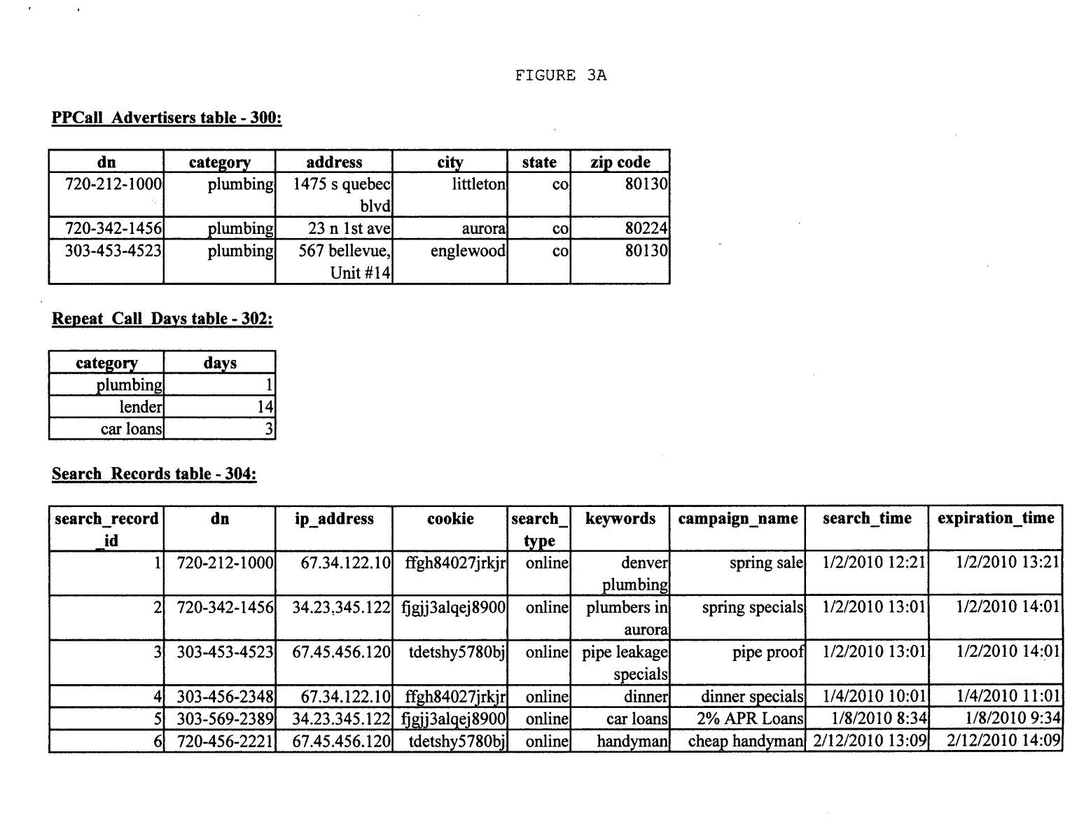

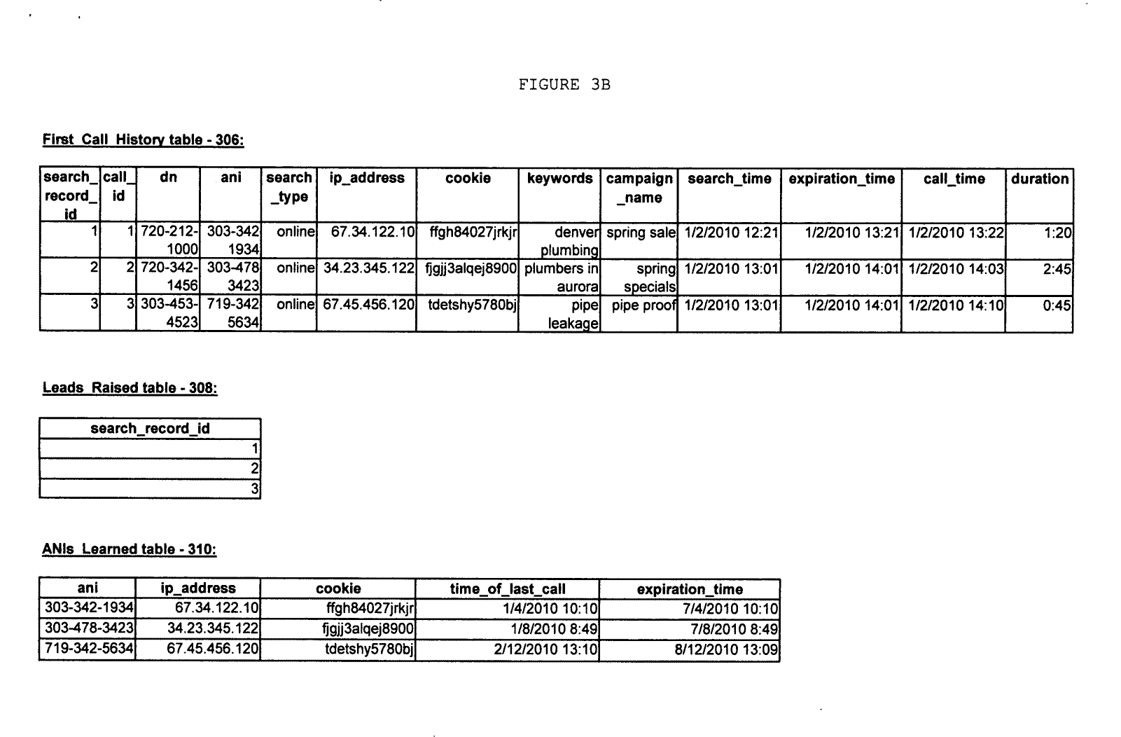

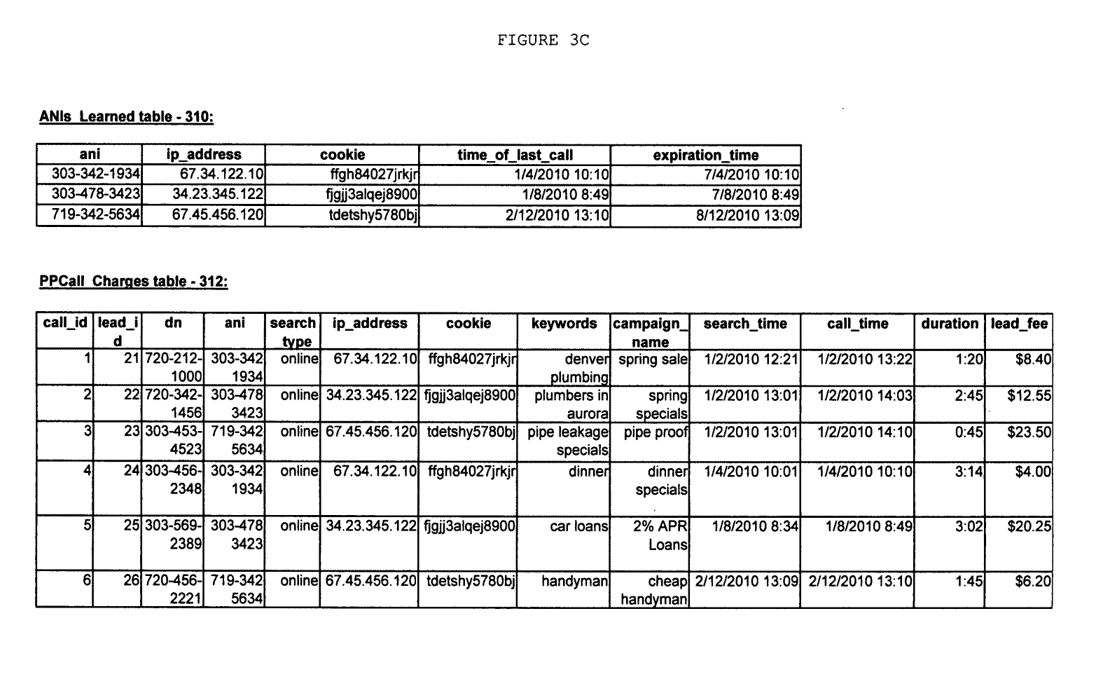

FIGS. 3A, 3B, and 3C are a perspective view of the LH Merchant DB tables, in accordance with the invention.

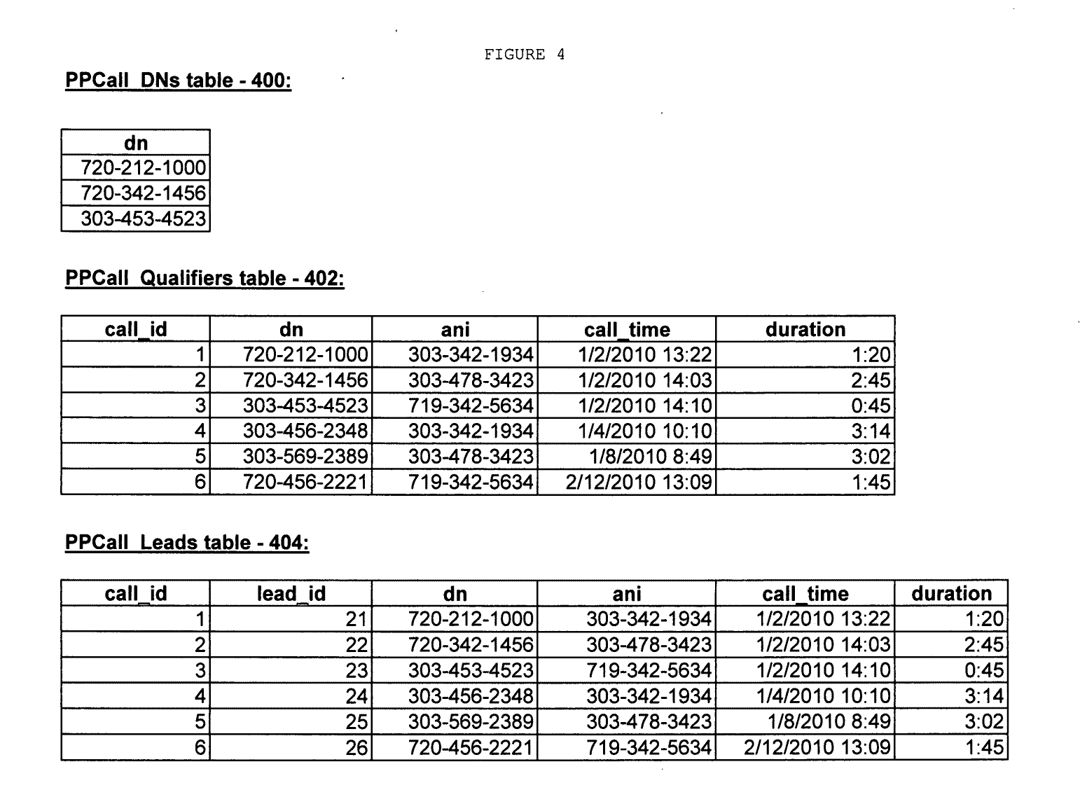

FIG. 4 is a perspective view of the LH CDR Server 206 tables, in accordance with the invention.

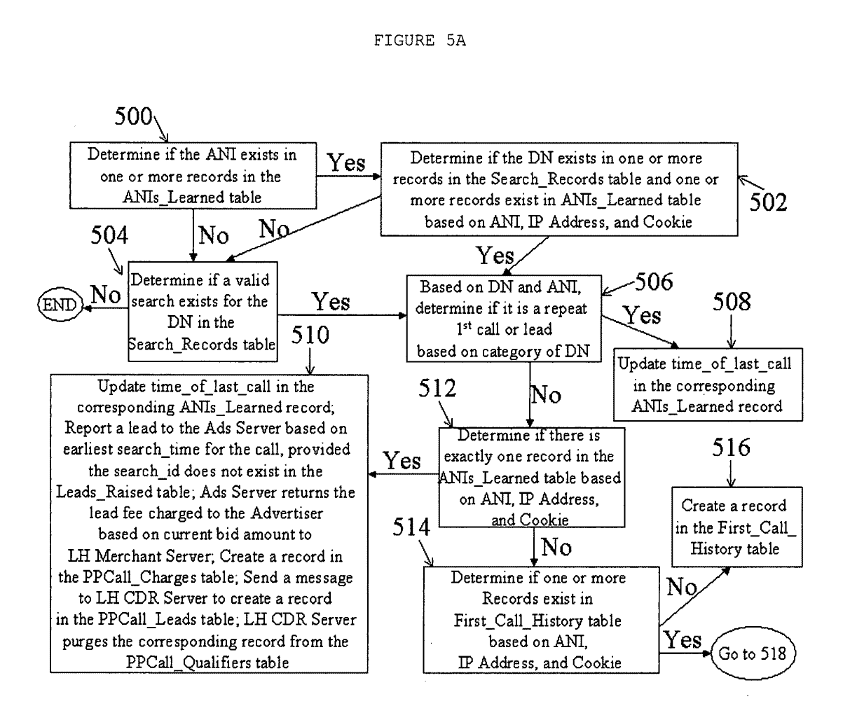

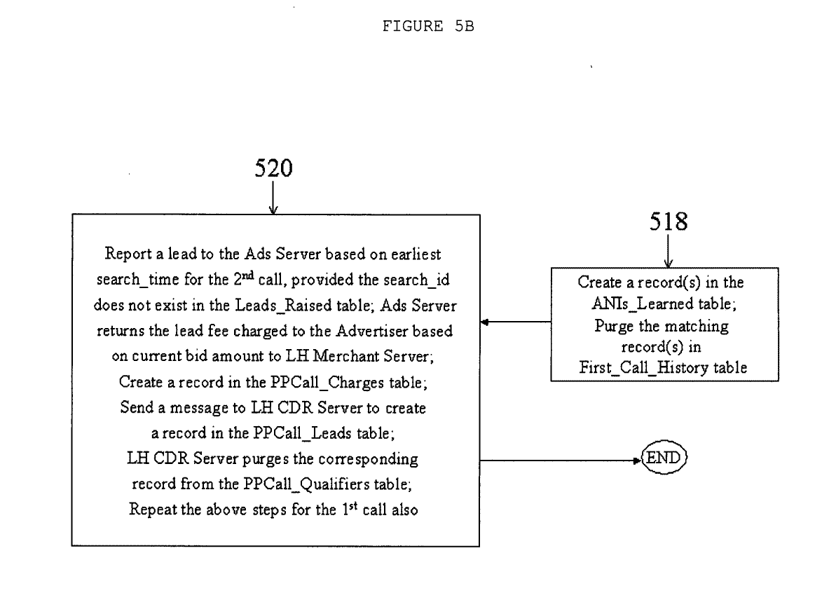

Upon receipt of a message from LH CDR Server 206, LH Merchant Server 108 validates the DN as being a valid PPCall_Advertiser 204 per the PPCallAdvertisers 300 table and then executes a Correlation Logic described in FIGS. 5A and 5B, in accordance with the invention.

More specifically, step 500 determines if the ANI received from LH CDR Server 206 exists in one or more records in the ANIs_Learned 310 table. If so, in step 502 it determines if the DN exists in one or more records in the Search_Records 304 table and one or more records exist in ANIs_Learned 310 table based on ANI received in the message from the LH CDR Server 206, and the IP Address and Cookie values of the said records of the ANIs_Learned 310 table match those values present in the said records of the Search_Records 304 table. If no records exist, then in step 504 Correlation Logic determines if a valid search exists for the DN in the Search_Records 304 table such that the call_time is greater than search_time. If so, the Correlation Logic proceeds to step 506 as explained below.

If step 502 returns more than one record, then in step 506 the Correlation Logic uses the DN and ANI received in the message from the LH CDR Server 206 to determine if it is a repeat 1st call or a repeat lead based on category of the said DN in the Repeat_Call_Days 302 table. If so, then in step 508 the Correlation Logic updates the time_of_last_call value to the call_time, provided a matching record for the said ANI, IP Address, and Cookie exists in the ANIs_Learned 310 table. If it is determined that it is a repeat 1st call, then the Correlation Logic ends without further processing. On the other hand, if step 502 does not return a record, then the Correlation Logic proceeds to step 504 as explained above.

In step 512, the Correlation Logic determines if there is exactly one record in the ANIs_Learned 310 table based on a match of the said ANI, a match of the said DN in a record of the Search_Records 304 table, and a match of the IP Address and Cookie values present in the said record of the Search_Records 304 table as those of the said record of the ANIs_Learned 310 table. If so, in step 510 it updates the time_of_last_call in the ANIs_Learned 310 table based on the said ANI, IP Address, and Cookie/Carrier UserID and then generates a lead_id for raising a lead message to the Ads Server 104, provided the search_record_id of the said record of the Search_Records 304 table is not already present in the Leads_Raised 308 table and the said event type is “disconnect” with the said “duration” value greater than a predetermined value as dictated by the search system. LH Merchant Server 108 then creates a record in the PPCall_Charges 312 table after capturing the lead fee returned by the Ads Server 104. In addition, the LH Merchant Server 108 sends a message to the LH CDR Server 206, which in turn creates a record in the PPCall_Leads 404 table and deletes the record in the PPCall_Qualifiers 402 table based on the said call_id value.

In step 514, the Correlation Logic determines if one or more records exist in First_Call_History 306 table that match the said ANI received in the message from LH CDR Server 206, match the DN in a record(s) of the Search_Records 304 table to which the call is attempted for delivery, and match the IP Address and Cookie values present in the said record(s) of the Search_Records 304 table as those of the said records of the First_Call_History 306 table. If no records exist, then Correlation Logic creates a record(s) in the First_Call_History 306 table per step 516. The expiration_time of the record(s) will be set to a value of current time+a predetermined value. On the other hand, if matching records exist in the First_Call_History 306 table, then per step 518 the Correlation Logic creates a record(s) in the ANIs_Learned 310 table, after which it purges the said record(s) in First_Call_History 306 table based on the said ANI, IP Address, and Cookie. In other words, the 2nd call being processed also is received from the said ANI for a matching record of the Search_Records 304 table with the said IP Address and Cookie as the 1st call, leading to the learning of the ANI.

In step 520, the Correlation Logic generates a lead_id for raising a lead message to the Ads Server 104 based on the earliest search_time of a matching record for the said DN, IP Address, and Cookie, provided the search_record_id of the said record in the Search_Records 304 table is not already present in the Leads_Raised 308 table and the said event type is “disconnect” with the said “duration” value greater than a predetermined value as dictated by the search system. LH Merchant Server 108 then creates a record in the PPCall_Charges 312 table after capturing the lead fee returned by the Ads Server 104. In addition, the LH Merchant Server 108 sends a message to the LH CDR Server 206, which in turn creates a record in the PPCall_Leads 404 table and deletes the record in the PPCall_Qualifiers 402 table based on the said call_id value.

A scheduled process running in LH Merchant Server 108 will purge records in the First_Call_History 306 table, provided the expiration_time is greater than current time. In addition, another scheduled process running in LH Merchant Server 108 will purge records in the ANIs_Learned 310 table, provided the current time is greater than the time_of_last_call+a predetermined value.

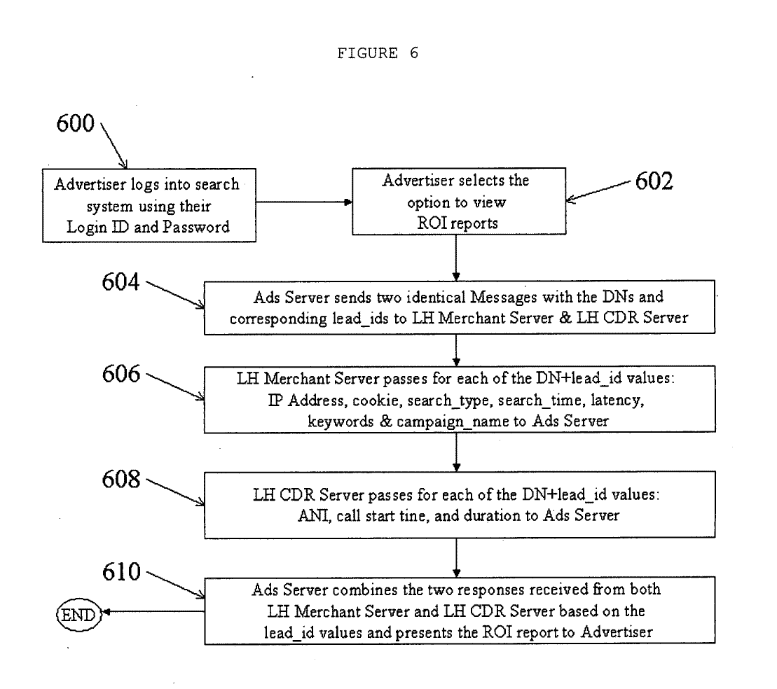

FIG. 6 is a perspective view of the ROI reports, in accordance with the invention. In step 600, the Advertiser 204 logs into their account with the search system using their Login ID and Password. In step 602, the Advertiser 204 selects the option to view the PPCall ROI reports. In step 604, the Ads Server 104 sends two identical messages to the LH Merchant Server 108 and LH CDR Server 206. The message consists of one or more DNs configured in the account as well as one or more said lead_ids that were reported to the Ads Server 104 when the Correlation Logic raised leads for calls delivered to the Advertiser 204 based on a valid search. The reason for sending two identical messages is that the LH Merchant Server 108 may not hold the said ANIs in clear-text form, subject to the privacy policy of the search system and, as such, only the LH CDR Server 206 contains the said ANIs in clear-text format for viewing by the Advertiser 204.

In step 606, LH Merchant Server 108 passes one or more datasets containing the said IP Address, Cookie, search_type, search_time, latency, keywords, and campaign_name for each of said lead_ids and DNs to the Ads Server 104. For privacy reasons, the said keywords and said campaign_name fields may be encrypted when originally received from the Search Server 102 as part of the search results.

In step 608, LH CDR Server 206 passes one or more datasets containing the said ANI, call_start_time, and duration for each of said lead_ids and DNs to the Ads Server 104.

In step 608, Ads Server 104 combines the two datasets received from LH Merchant Server 108 and LH CDR Server 206 based on the said lead_ids and DNs and presents a ROI report to the Advertiser 204. In case the said keywords and campaign_name fields are encrypted as passed originally from the Search Server 102 as part of the search results, then the Ads Server 104 assumes the responsibility for decrypting the values before presenting the ROI report to the Advertiser 204.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims:

1. A pay-per-call ad system for providing proof that the call is associated to an online or mobile search and in an anonymous manner, comprising:
means for performing one or more online and mobile searches;
means for storing one or more ppcalls ads comprising one or more keywords associated with one or more campaign names and configured by advertiser;
means for receiving relevant one or more ads from ads server and natural results from the organic listings db; consolidating the paid ads and natural results for presentation to the user; and passing the one or more search results containing one or more ppcall ads info consisting of search time, search type (online or mobile), ip address for online searches/carrier userid representing the mobile and sent through the wap gateway of the mobile carrier for mobile searches (maybe encrypted), cookie (maybe encrypted), dn, keywords (maybe encrypted or proxy), and campaign_name (maybe encrypted or proxy) to lh merchant server;
means for receiving one or more search results from the search server and creating one or more records in the search_records table containing the search_record_id, search_time, ip address for online searches/carrier userid for mobile searches (maybe encrypted), cookie (maybe encrypted), search_type, dn, keywords (maybe encrypted), and campaign_name (maybe encrypted), provided the dn is present in the ppcall_advertisers table; creating one or more records in the anis_learned table if either the said ip address/carrier userid or cookie had changed as compared to the existing one or more records in the anis_learned table; creating one or more records in the first_call_history table if either the said ip address/carrier userid or cookie had changed as compared to the existing one or more records in the first_call_history table; updating the existing one or more records in the first_call_history table if the said ip address/carrier userid and cookie had not changed; executing correlation logic to a) create one or more records in the first_call_history table for the 1st call delivered, provided the dn to which the call is attempted for delivery is present in the ppcall_advertisers table and a valid one or more records containing the said dn are present in the search_records table; b) learn an ani based on a non-repeat 2nd call from the same ani as that present in one or more records of the first_call_history table and the same ip address/carrier userid and cookie values present in the said records of the first_call_history table as that present in one or more records of the search_records table and the said records of the search_records table containing the same dn to which the said call is attempted for delivery; and c) match the ani placing the call to one record in the anis_learned table containing the same ani and match the ip address/carrier userid and cookie contained in the said record of the anis_learned table against one record of the search_records table containing the same ip address/carrier userid and cookie and match the dn in the said record of the search_records table to which the said subsequent call is delivered; raising one or more leads to ads server for the 1st and/or 2nd calls when an ani is learned or when a subsequent call is delivered from an already learned ani based on earliest search_time while ensuring that there is no more than one lead for an impression of the ad by verifying that the search_record_id of the said record of the search_records table is not already present in the leads_raised table, provided the said call event is a “disconnect” and the said duration of the call meets a predetermined value; creating one or more records in the ppcall_charges table with the said lead fee received from the ads server; reporting the said one or more leads to lh cdr server; and facilitating the viewing of the roi report by the advertiser;
means for transferring the call from the tracking phone number used in the ppcall ad to the existing phone number of the advertiser, or delivering the call directly to the existing phone number of the advertiser; and sending a call event message to lh cdr server wherein the said message includes dn, ani, event type (busy, no answer, answer, and disconnect), call_time, and duration (applies only to disconnect);
means for receiving one or more call event messages such as busy, no answer, answer, and disconnect from the terminating switch, where the message contains ani, dn, time, duration (applies only to disconnect event), and event type; verifying that the dn is present in the ppcall_dns table; generating a call_id for each call event message received from the said terminating switch; creating one or more records in the ppcall_qualifiers table containing the call_id, ani, dn, call time, and duration; forwarding one or more call events such as busy, no answer, and disconnect with the parameters of call_id, ani (maybe encrypted), dn, call time, and duration to lh merchant server; creating one or more leads in the ppcall_leads table upon receipt of one or more valid leads from the lh merchant server; and facilitating the viewing of roi report by the advertiser;
means for creating an account in the search system's ads server; creating one or more ppcall campaigns under the account for one or more dns, each containing one or more ad groups, which in turn contains one or more keywords; bidding for one or more keywords; being billed for one or more valid leads delivered as calls per the correlation logic; and being able to view the roi report;
means for storing one or more ppcall advertisers' information that signed up with the search system's ads server;
means for storing one or more of the ppcall ads info received in the search results message from the search server with an expiration_time equal to the search_time+a predetermined value;
means for storing one or more 1st calls with an expiration_time equal to the search_time+a predetermined value, provided the dn to which the call is attempted for delivery is found in one or more valid records of the search_records table; ensuring that when a non-repeat 2nd call attempt is received, the said correlation logic can make a determination as to whether or not the call is from the same ani as that present in one or more records of the first_call_history table and for a dn present in a valid one or more records of the search_records table and the ip address/carrier userid and cookie values present in the said records of the first_call_history table match those in the said records of the search_records table; and updating one or more existing records;
means for storing one or more anis learned against one or more said ip address/carrier userid and cookie from one or more records of the search_records table per the said correlation logic; updating one or more existing records;
means for storing one or more valid leads per the said correlation logic, associated with one or more anis as well as one or more ip address/carrier userid and cookie from one or more records in the search_records table that also contains a dn to which the call is delivered and for which a lead fee based on the bid amount is charged;
means for storing one or more ppcall advertisers' information that signed up with the search system's ads server; and verifying that the dn passed from the terminating switch is a valid ppcall advertiser before the lh cdr server processing further the incoming message from the terminating switch;
means for storing one or more call events received from the terminating switch, along with a call_id generated by the lh cdr server, after determining that the dn contained in the message is a valid ppcall advertiser; and maintaining the said call events in the table until such time as the lh merchant server reports the said call_id either a lead or non-lead, at which the said record based on the said call_id will be purged;
means for storing one or more leads reported by the said correlation logic;
means for storing one or more leads raised by the said correlation logic so as to ensure that no more than one lead is raised for an impression of the ppcall ad; and
means for storing one or more repeat call interval for one or more categories of ppcall advertisers so as to allow non-billable leads for calls placed during the repeat call interval.

2. The pay-per-call ad system in accordance with claim 1, wherein said means for performing one or more online and mobile searches comprises an user.

3. The pay-per-call ad system in accordance with claim 1, wherein said means for storing one or more ppcalls ads comprising one or more keywords associated with one or more campaign names and configured by advertiser comprises an ads server.

4. The pay-per-call ad system in accordance with claim 1, wherein said means for receiving relevant one or more ads from ads server and natural results from the organic listings db; consolidating the paid ads and natural results for presentation to the user; and passing the one or more search results containing one or more ppcall ads info consisting of search time, search type (online or mobile), ip address for online searches/carrier userid representing the mobile and sent through the wap gateway of the mobile carrier for mobile searches (maybe encrypted), cookie (maybe encrypted), dn, keywords (maybe encrypted or proxy), and campaign_name (maybe encrypted or proxy) to lh merchant server comprises a search server.

5. The pay-per-call ad system in accordance with claim 1, wherein said means for receiving one or more search results from the search server and creating one or more records in the search_records table containing the search_record_id, search_time, ip address for online searches/carrier userid for mobile searches (maybe encrypted), cookie (maybe encrypted), search_type, dn, keywords (maybe encrypted), and campaign_name (maybe encrypted), provided the dn is present in the ppcall_advertisers table; creating one or more records in the anis_learned table if either the said ip address/carrier userid or cookie had changed as compared to the existing one or more records in the anis_learned table; creating one or more records in the first_call_history table if either the said ip address/carrier userid or cookie had changed as compared to the existing one or more records in the first_call_history table; updating the existing one or more records in the first_call_history table if the said ip address/carrier userid and cookie had not changed; executing correlation logic to a) create one or more records in the first_call_history table for the 1st call delivered, provided the dn to which the call is attempted for delivery is present in the ppcall_advertisers table and a valid one or more records containing the said dn are present in the search_records table; b) learn an ani based on a non-repeat 2nd call from the same ani as that present in one or more records of the first_call_history table and the same ip address/carrier userid and cookie values present in the said records of the first_call_history table as that present in one or more records of the search_records table and the said records of the search_records table containing the same dn to which the said call is attempted for delivery; and c) match the ani placing the call to one record in the anis_learned table containing the same ani and match the ip address/carrier userid and cookie contained in the said record of the anis_learned table against one record of the search_records table containing the same ip address/carrier userid and cookie and match the dn in the said record of the search_records table to which the said subsequent call is delivered; raising one or more leads to ads server for the 1st and/or 2nd calls when an ani is learned or when a subsequent call is delivered from an already learned ani based on earliest search_time while ensuring that there is no more than one lead for an impression of the ad by verifying that the search_record_id of the said record of the search_records table is not already present in the leads_raised table, provided the said call event is a “disconnect” and the said duration of the call meets a predetermined value; creating one or more records in the ppcall_charges table with the said lead fee received from the ads server; reporting the said one or more leads to lh cdr server; and facilitating the viewing of the roi report by the advertiser comprises a lh merchant server.

6. The pay-per-call ad system in accordance with claim 1, wherein said means for transferring the call from the tracking phone number used in the ppcall ad to the existing phone number of the advertiser, or delivering the call directly to the existing phone number of the advertiser; and sending a call event message to lh cdr server wherein the said message includes dn, ani, event type (busy, no answer, answer, and disconnect), call_time, and duration (applies only to disconnect) comprises a terminating switch.

7. The pay-per-call ad system in accordance with claim 1, wherein said means for receiving one or more call event messages such as busy, no answer, answer, and disconnect from the terminating switch, where the message contains ani, dn, time, duration (applies only to disconnect event), and event type; verifying that the dn is present in the ppcall_dns table; generating a call_id for each call event message received from the said terminating switch; creating one or more records in the ppcall_qualifiers table containing the call_id, ani, dn, call time, and duration; forwarding one or more call events such as busy, no answer, and disconnect with the parameters of call_id, ani (maybe encrypted), dn, call time, and duration to lh merchant server; creating one or more leads in the ppcall_leads table upon receipt of one or more valid leads from the lh merchant server; and facilitating the viewing of roi report by the advertiser comprises a lh cdr server.

8. The pay-per-call ad system in accordance with claim 1, wherein said means for creating an account in the search system's ads server; creating one or more ppcall campaigns under the account for one or more dns, each containing one or more ad groups, which in turn contains one or more keywords; bidding for one or more keywords; being billed for one or more valid leads delivered as calls per the correlation logic; and being able to view the roi report comprises an advertiser.

9. The pay-per-call ad system in accordance with claim 1, wherein said means for storing one or more ppcall advertisers' information that signed up with the search system's ads server comprises a ppcall_advertisers.

10. The pay-per-call ad system in accordance with claim 1, wherein said means for storing one or more of the ppcall ads info received in the search results message from the search server with an expiration_time equal to the search_time+a predetermined value comprises a search_records.

11. The pay-per-call ad system in accordance with claim 1, wherein said means for storing one or more 1st calls with an expiration_time equal to the search_time+a predetermined value, provided the do to which the call is attempted for delivery is found in one or more valid records of the search_records table; ensuring that when a non-repeat 2nd call attempt is received, the said correlation logic can make a determination as to whether or not the call is from the same ani as that present in one or more records of the first_call_history table and for a dn present in a valid one or more records of the search_records table and the ip address/carrier userid and cookie values present in the said records of the first_call_history table match those in the said records of the search_records table; and updating one or more existing records comprises a first_call_history.

12. The pay-per-call ad system in accordance with claim 1, wherein said means for storing one or more anis learned against one or more said ip address/carrier userid and cookie from one or more records of the search_records table per the said correlation logic; updating one or more existing records comprises an anis_learned.

13. The pay-per-call ad system in accordance with claim 1, wherein said means for storing one or more valid leads per the said correlation logic, associated with one or more anis as well as one or more ip address/carrier userid and cookie from one or more records in the search_records table that also contains a dn to which the call is delivered and for which a lead fee based on the bid amount is charged comprises a ppcall_charges.

14. The pay-per-call ad system in accordance with claim 1, wherein said means for storing one or more ppcall advertisers' information that signed up with the search system's ads server; and verifying that the dn passed from the terminating switch is a valid ppcall advertiser before the lh cdr server processing further the incoming message from the terminating switch comprises a ppcall_dns.

15. The pay-per-call ad system in accordance with claim 1, wherein said means for storing one or more call events received from the terminating switch, along with a call_id generated by the lh cdr server, after determining that the dn contained in the message is a valid ppcall advertiser; and maintaining the said call events in the table until such time as the lh merchant server reports the said call_id either a lead or non-lead, at which the said record based on the said call_id will be purged comprises a ppcall_qualifiers.

16. The pay-per-call ad system in accordance with claim 1, wherein said means for storing one or more leads reported by the said correlation logic comprises a ppcall_leads.

17. The pay-per-call ad system in accordance with claim 1, wherein said means for storing one or more leads raised by the said correlation logic so as to ensure that no more than one lead is raised for an impression of the ppcall ad comprises a leads_raised.

18. The pay-per-call ad system in accordance with claim 1, wherein said means for storing one or more repeat call interval for one or more categories of ppcall advertisers so as to allow non-billable leads for calls placed during the repeat call interval comprises a repeat_call_days.

19. A pay-per-call ad system for providing proof that the call is associated to an online or mobile search and in an anonymous manner, comprising:
an user, for performing one or more online and mobile searches;
an ads server, for storing one or more ppcalls ads comprising one or more keywords associated with one or more campaign names and configured by advertiser;
a search server, for receiving relevant one or more ads from ads server and natural results from the organic listings db; consolidating the paid ads and natural results for presentation to the user; and passing the one or more search results containing one or more ppcall ads info consisting of search time, search type (online or mobile), address for online searches/carrier userid representing the mobile and sent through the wap gateway of the mobile carrier for mobile searches (maybe encrypted), cookie (maybe encrypted), dn, keywords (maybe encrypted or proxy), and campaign_name (maybe encrypted or proxy) to lh merchant server;
a lh merchant server, for receiving one or more search results from the search server and creating one or more records in the search_records table containing the search_record_id, search_time, ip address for online searches/carrier userid for mobile searches (maybe encrypted), cookie (maybe encrypted), search_type, dn, keywords (maybe encrypted), and campaign_name (maybe encrypted), provided the dn is present in the ppcall_advertisers table; creating one or more records in the anis_learned table if either the said ip address/carrier userid or cookie had changed as compared to the existing one or more records in the anis_learned table; creating one or more records in the first_call_history table if either the said ip address/carrier userid or cookie had changed as compared to the existing one or more records in the first_call_history table; updating the existing one or more records in the first_call_history table if the said ip address/carrier userid and cookie had not changed; executing correlation logic to a) create one or more records in the first_call_history table for the 1st call delivered, provided the dn to which the call is attempted for delivery is present in the ppcall_advertisers table and a valid one or more records containing the said dn are present in the search_records table; b) learn an ani based on a non-repeat 2nd call from the same ani as that present in one or more records of the first_call_history table and the same ip address/carrier userid and cookie values present in the said records of the first_call_history table as that present in one or more records of the search_records table and the said records of the search_records table containing the same dn to which the said call is attempted for delivery; and c) match the ani placing the call to one record in the anis_learned table containing the same ani and match the ip address/carrier userid and cookie contained in the said record of the anis_learned table against one record of the search_records table containing the same ip address/carrier userid and cookie and match the dn in the said record of the search_records table to which the said subsequent call is delivered; raising one or more leads to ads server for the 1st and/or 2nd calls when an ani is learned or when a subsequent call is delivered from an already learned ani based on earliest search_time while ensuring that there is no more than one lead for an impression of the ad by verifying that the search_record_id of the said record of the search_records table is not already present in the leads_raised table, provided the said call event is a “disconnect” and the said duration of the call meets a predetermined value; creating one or more records in the ppcall_charges table with the said lead fee received from the ads server; reporting the said one or more leads to lh cdr server; and facilitating the viewing of the roi report by the advertiser;
a terminating switch, for transferring the call from the tracking phone number used in the ppcall ad to the existing phone number of the advertiser, or delivering the call directly to the existing phone number of the advertiser; and sending a call event message to lh cdr server wherein the said message includes dn, ani, event type (busy, no answer, answer, and disconnect), call_time, and duration (applies only to disconnect);
a lh cdr server, for receiving one or more call event messages such as busy, no answer, answer, and disconnect from the terminating switch, where the message contains ani, dn, time, duration (applies only to disconnect event), and event type; verifying that the dn is present in the ppcall_dns table; generating a call_id for each call event message received from the said terminating switch; creating one or more records in the ppcall_qualifiers table containing the call_id, ani, dn, call time, and duration; forwarding one or more call events such as busy, no answer, and disconnect with the parameters of call_id, ani (maybe encrypted), dn, call time, and duration to lh merchant server; creating one or more leads in the ppcall_leads table upon receipt of one or more valid leads from the lh merchant server; and facilitating the viewing of roi report by the advertiser;
an advertiser, for creating an account in the search system's ads server; creating one or more ppcall campaigns under the account for one or more dns, each containing one or more ad groups, which in turn contains one or more keywords; bidding for one or more keywords; being billed for one or more valid leads delivered as calls per the correlation logic; and being able to view the roi report;
a ppcall_advertisers, for storing one or more ppcall advertisers' information that signed up with the search system's ads server;
a search_records, for storing one or more of the ppcall ads info received in the search results message from the search server with an expiration_time equal to the search_time+a predetermined value;
a first_call_history, for storing one or more 1st calls with an expiration_time equal to the search_time+a predetermined value, provided the dn to which the call is attempted for delivery is found in one or more valid records of the search_records table; ensuring that when a non-repeat 2nd call attempt is received, the said correlation logic can make a determination as to whether or not the call is from the same ani as that present in one or more records of the first_call_history table and for a dn present in a valid one or more records of the search_records table and the ip address/carrier userid and cookie values present in the said records of the first_call_history table match those in the said records of the search_records table; and updating one or more existing records;
an anis_learned, for storing one or more anis learned against one or more said ip address/carrier userid and cookie from one or more records of the search_records table per the said correlation logic; updating one or more existing records;
a ppcall_charges, for storing one or more valid leads per the said correlation logic, associated with one or more anis as well as one or more ip address/carrier userid and cookie from one or more records in the search_records table that also contains a dn to which the call is delivered and for which a lead fee based on the bid amount is charged;
a ppcall_dns, for storing one or more ppcall advertisers' information that signed up with the search system's ads server; and verifying that the dn passed from the terminating switch is a valid ppcall advertiser before the lh cdr server processing further the incoming message from the terminating switch;
a ppcall_qualifiers, for storing one or more call events received from the terminating switch, along with a call_id generated by the lh cdr server, after determining that the dn contained in the message is a valid ppcall advertiser; and maintaining the said call events in the table until such time as the lh merchant server reports the said call_id either a lead or non-lead, at which the said record based on the said call_id will be purged;
a ppcall_leads, for storing one or more leads reported by the said correlation logic;
a leads_raised, for storing one or more leads raised by the said correlation logic so as to ensure that no more than one lead is raised for an impression of the ppcall ad; and
a repeat_call_days, for storing one or more repeat call interval for one or more categories of ppcall advertisers so as to allow non-billable leads for calls placed during the repeat call interval.

20. A pay-per-call ad system for providing proof that the call is associated to an online or mobile search and in an anonymous manner, comprising:
an user, for performing one or more online and mobile searches;
an ads server, for storing one or more ppcalls ads comprising one or more keywords associated with one or more campaign names and configured by advertiser;
a search server, for receiving relevant one or more ads from ads server and natural results from the organic listings db; consolidating the paid ads and natural results for presentation to the user; and passing the one or more search results containing one or more ppcall ads info consisting of search time, search type (online or mobile), address for online searches/carrier userid representing the mobile and sent through the wap gateway of the mobile carrier for mobile searches (maybe encrypted), cookie (maybe encrypted), dn, keywords (maybe encrypted or proxy), and campaign_name (maybe encrypted or proxy) to lh merchant server;
a lh merchant server, for receiving one or more search results from the search server and creating one or more records in the search_records table containing the search_record_id, search_time, ip address for online searches/carrier userid for mobile searches (maybe encrypted), cookie (maybe encrypted), search_type, dn, keywords (maybe encrypted), and campaign_name (maybe encrypted), provided the dn is present in the ppcall_advertisers table; creating one or more records in the anis_learned table if either the said ip address/carrier userid or cookie had changed as compared to the existing one or more records in the anis_learned table; creating one or more records in the first_call_history table if either the said ip address/carrier userid or cookie had changed as compared to the existing one or more records in the first_call_history table; updating the existing one or more records in the first_call_history table if the said ip address/carrier userid and cookie had not changed; executing correlation logic to a) create one or more records in the first_call_history table for the 1st call delivered, provided the dn to which the call is attempted for delivery is present in the ppcall_advertisers table and a valid one or more records containing the said dn are present in the search_records table; b) learn an ani based on a non-repeat 2nd call from the same ani as that present in one or more records of the first_call_history table and the same ip address/carrier userid and cookie values present in the said records of the first_call_history table as that present in one or more records of the search_records table and the said records of the search_records table containing the same dn to which the said call is attempted for delivery; and c) match the ani placing the call to one record in the anis_learned table containing the same ani and match the ip address/carrier userid and cookie contained in the said record of the anis_learned table against one record of the search_records table containing the same ip address/carrier userid and cookie and match the dn in the said record of the search_records table to which the said subsequent call is delivered; raising one or more leads to ads server for the 1st and/or 2nd calls when an ani is learned or when a subsequent call is delivered from an already learned ani based on earliest search_time while ensuring that there is no more than one lead for an impression of the ad by verifying that the search_record_id of the said record of the search_records table is not already present in the leads_raised table, provided the said call event is a “disconnect” and the said duration of the call meets a predetermined value; creating one or more records in the ppcall_charges table with the said lead fee received from the ads server; reporting the said one or more leads to lh cdr server; and facilitating the viewing of the roi report by the advertiser;
a terminating switch, for transferring the call from the tracking phone number used in the ppcall ad to the existing phone number of the advertiser, or delivering the call directly to the existing phone number of the advertiser; and sending a call event message to lh cdr server wherein the said message includes dn, ani, event type (busy, no answer, answer, and disconnect), call_time, and duration (applies only to disconnect);
a lh cdr server, for receiving one or more call event messages such as busy, no answer, answer, and disconnect from the terminating switch, where the message contains ani, dn, time, duration (applies only to disconnect event), and event type; verifying that the dn is present in the ppcall_dns table; generating a call_id for each call event message received from the said terminating switch; creating one or more records in the ppcall_qualifiers table containing the call_id, ani, dn, call time, and duration; forwarding one or more call events such as busy, no answer, and disconnect with the parameters of call_id, ani (maybe encrypted), dn, call time, and duration to lh merchant server; creating one or more leads in the ppcall_leads table upon receipt of one or more valid leads from the lh merchant server; and facilitating the viewing of roi report by the advertiser;
an advertiser, for creating an account in the search system's ads server; creating one or more ppcall campaigns under the account for one or more dns, each containing one or more ad groups, which in turn contains one or more keywords; bidding for one or more keywords; being billed for one or more valid leads delivered as calls per the correlation logic; and being able to view the roi report;
a ppcall_advertisers, for storing one or more ppcall advertisers' information that signed up with the search system's ads server;
a search_records, for storing one or more of the ppcall ads info received in the search results message from the search server with an expiration_time equal to the search_time+a predetermined value;
a first_call_history, for storing one or more 1st calls with an expiration_time equal to the search_time+a predetermined value, provided the dn to which the call is attempted for delivery is found in one or more valid records of the search_records table; ensuring that when a non-repeat 2nd call attempt is received, the said correlation logic can make a determination as to whether or not the call is from the same ani as that present in one or more records of the first_call_history table and for a dn present in a valid one or more records of the search_records table and the ip address/carrier userid and cookie values present in the said records of the first_call_history table match those in the said records of the search_records table; and updating one or more existing records;
an anis_learned, for storing one or more anis learned against one or more said ip address/carrier userid and cookie from one or more records of the search_records table per the said correlation logic; updating one or more existing records;
a ppcall_charges, for storing one or more valid leads per the said correlation logic, associated with one or more anis as well as one or more ip address/carrier userid and cookie from one or more records in the search_records table that also contains a dn to which the call is delivered and for which a lead fee based on the bid amount is charged;
a ppcall_dns, for storing one or more ppcall advertisers' information that signed up with the search system's ads server; and verifying that the dn passed from the terminating switch is a valid ppcall advertiser before the lh cdr server processing further the incoming message from the terminating switch;
a ppcall_qualifiers, for storing one or more call events received from the terminating switch, along with a call_id generated by the lh cdr server, after determining that the dn contained in the message is a valid ppcall advertiser; and maintaining the said call events in the table until such time as the lh merchant server reports the said call_id either a lead or non-lead, at which the said record based on the said call_id will be purged;
a ppcall_leads, for storing one or more leads reported by the said correlation logic;
a leads_raised, for storing one or more leads raised by the said correlation logic so as to ensure that no more than one lead is raised for an impression of the ppcall ad; and
a repeat_call_days, for storing one or more repeat call interval for one or more categories of ppcall advertisers so as to allow non-billable leads for calls placed during the repeat call interval.
